(19) United States
(12) Patent Application Publication
(10) Pub. No.: US 2015/0050178 A1
(43) Pub. Date: Feb. 19, 2015

(54) Soft Magnetic Composite Materials

(71) Applicant: THE HONG KONG UNIVERSITY OF SCIENCE AND TECHNOLOG, Hong Kong (CN)

(72) Inventors: Chi Ming Chan, Hong Kong (CN); Kai Mo Ng, Hong Kong (CN)

(21) Appl. No.: 14/386,536

(22) PCT Filed: Jan. 30, 2013
(86) PCT No.: PCT/CN2013/000092

§ 371 Date: Sep. 19, 2014

Related U.S. Application Data
(60) Provisional application No. 61/687,509, filed on Apr. 26, 2012.

(51) Int. Cl. H01F 1/24; B22F 3/14; B22F 1/02; B22F 1/00; H01F 41/02; H01F 1/147

(52) U.S. Cl. CPC H01F 1/24; H01F 41/02; H01F 1/147; B22F 1/02; B22F 1/0059; B22F 3/14
USPC 419/35; 427/127

(57) ABSTRACT

A soft magnetic composite (SMC) material is formed from atomized ferromagnetic particles. The particles of a predetermined size range are formed and are coated with at least one layer of electrically insulating nano-sized inorganic fillers to form insulated ferromagnetic powder as the SMC material. The particles are further coated with a lubricating agent to facilitated demoulding.

### RELATED APPLICATION

The present Patent Application claims priority to Provisional Patent Application No. 61/687,509 filed on 26 Apr. 2012, which is assigned to the assignee hereof and filed by the inventors hereof and which is incorporated by reference herein.

### BACKGROUND

1. Field

The present disclosure generally relates to the formulation of Soft

Magnetic Composite (SMC) materials that are employed in soft magnetic cores by powder metallurgy. More specifically, the present disclosure provides methods of making SMC materials containing at least one insulating spacer layer of nanoparticles.

2. Background

Soft magnetic composite (SMC) materials are increasingly found in many electromagnetic devices such as motors, generators, fuel injectors and ignition coils. SMC materials generally consist of ferromagnetic particles (i.e., iron particles) whose surfaces are coated with one or more layers of electrical insulating materials. Their usual target applications are divided into two groups:

(i) direct current (DC) or low frequency applications, and

(ii) high frequency (i.e., >1 kHz) applications.

For DC applications, the soft magnetic components are prepared by traditional processing methods such as punching or stamping laminated high density steel sheets; however, some very complex and small core components are difficult to manufacture by these methods. Preparing SMCs by powder metallurgy (PM) will allow more flexible design and fabrication of complex 3-dimensional isotropic magnetic core components. An additional advantage of this SMC materials technology is that, no scrap metal will be generated during the fabrication of the soft magnetic cores.

Soft magnetic materials are different from the hard magnetic materials in that they are easily magnetized and demagnetized under external magnetic fields. Generally, soft magnetic materials have relatively low values of coercivities typically <1 kA/m and high magnetic permeability. The ideal SMC material has excellent magnetic properties (i.e., high permeability and high magnetic saturation) and low eddy current losses. To obtain the best magnetic properties, the purity of the iron powder must be at least 99% and the particle size must be between 10 and 600 microns. To ensure low eddy current losses, each iron particle must be coated with one or more layers of electrical insulating material.

Two major aspects of the SMC material composition are focused in the field: (1) properties and characterization of different ferromagnetic particles, e.g., Fe, Fe—Si, Fe—Ni; and (2) development of an electrical insulating coating methodology. More recently, the use of lubricating agents in these materials to facilitate the demoulding of components has also taken added significance.

In general, soft magnetic composite (SMC) materials are prepared by coating a micron-sized iron powder with an electrically insulating material such as phosphate or epoxy polymer. The powder is mixed with an organic lubricant, then compacted and heat treated at 300-700° C. until a soft magnetic core is formed. Warm compaction is employed which produces cores that are typically 1-2% denser than those obtained by the green compaction procedure. Conventional methods for the preparation of these electrically insulating coatings include in-situ formation of a phosphate insulating layer on the iron particle surface and direct mixing of a polymer with the iron powder. The components are then heat treated to release the stresses generated during the compaction of the SMC. The temperature and duration of treatment are highly dependent on the insulating material.

Methods of preparing SMC materials, including inorganic acid (i.e., H₃PO₄, H₃BO₃) treatment or coating a layer of organic polymer resin on the surfaces of iron particles, are well known.

### SUMMARY

Soft magnetic composite (SMC) material is formed by forming atomized ferromagnetic particles of a predetermined size range. The particles are coated with at least one layer of electrically insulating inorganic nanofillers to form an insulated ferromagnetic powder as the SMC material. The particles are further coated with a lubricating agent to facilitate demoulding.

### BRIEF DESCRIPTION OF THE DRAWINGS

FIG. 1 is a schematic diagram of a soft magnetic composite (SMC) comprising iron particles coated with a layer(s) of electrically insulating inorganic nanoparticles.

FIG. 2 is a scanning electron microscope (SEM) photomicrograph of the compacted SMC core sample S4 comprising an iron powder coated with halloysite nanotubes for electrical insulation.

FIG. 3 is a SEM photomicrograph of the compacted SMC core sample

S5 comprising an iron powder coated with nano-sized silica (Aerosil R-202) for electrical insulation.

### DETAILED DESCRIPTION

### Overview

The present disclosure relates to a soft magnetic composite (SMC) material that has good magnetic properties, high electrical resistance, and thus low eddy current losses. This SMC material comprises water-atomized iron particles or iron sponge with sizes ranging from 10 to 600 microns. These particles are coated with one or more layers of electrical insulating inorganic nanofillers, examples of which include halloysite nanotubes (HNTs), kaolin, titanium dioxide, talc, alumina, silica, among others.

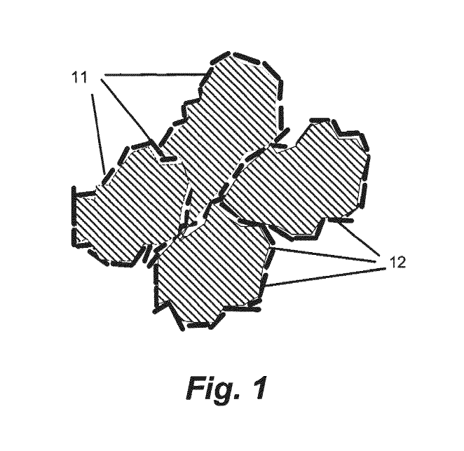

FIG. 1 is a schematic diagram of an SMC comprising iron particles 12 coated with inorganic nanoparticles 11 for electrical insulation. There is at least one insulating spacer layer of nanoparticles on the surface of the ferromagnetic powder which has irregular particle shapes and sizes ranging from 10 to 600 microns. These iron particles are coated with a sub-monolayer, monolayer or multi-layer of electrical insulating inorganic nanoparticles such as those from alumina, silica, talc, aluminosilicates, kaolin, and titanium dioxide. The coated iron powder forms an insulated ferromagnetic iron powder or SMC. The use of inorganic nanoparticles as a spacer layer enhances the electrical insulation capability of the ferromagnetic iron powder.

In fabricating the insulated ferromagnetic iron powder, the iron powder is added to a suspension containing nanoparticles and a solvent (e.g., alcohol) or without solvent (e.g. dry method). The mixing together of the iron powder and the nanoparticles is achieved using a blender or other mechanical stirring device. The mixture is then dried in a vacuum oven to remove the solvent. An organic lubricant is added to facilitate the demoulding of the components after compaction of the SMC at high temperatures.

Halloysite and kaolin are formed from clay with the empirical formula of Al₂Si₂O₅(OH)₄ . The clay can be found in natural environments and is electrically nonconductive with very good thermal stability. As can be seen, the main constituents of halloysite and kaolin are aluminum, silicon, oxygen and hydrogen. Halloysite and kaolin have highly diversified morphologies (particles or tubes) with sizes ranging from a few nanometers to sub-micron. Typical specific surface areas (BET method) of Halloysite and kaolin are 20-30 m²/g.

### Magnetic Particles

Common practices in the preparation of SMC materials include using iron particles as the ferromagnetic core, because iron is readily available from many metal powder manufacturers worldwide. The purity of the iron powder should be >99%. The particle sizes should be between 10 to 600 microns to facilitate the compaction of the SMC into high density magnetic core components with improved magnetic properties. Therefore iron sponge or water-atomized iron powders are ideal raw materials.

### Electrical Insulating Coating

According to the SMC requirements, the electrical insulating coating or layer should be uniform and thin (e.g., <200 nm). The majority of SMC patents already filed are based on treating the iron particle surface with inorganic acids, for example phosphoric acid (H₃PO₄), to form an insulating layer of iron phosphate (Fe₂PO₄). Alternatively, boric acid (H₃BO₃) can be combined with alkali compounds to form an insulating layer on the iron particle surface. Many other inorganic materials can be used to form the insulating coating. The insulating coating may contain more than one metal oxide layer produced with phosphoric acid, boric acid or silicic acid.

In the production of SMCs the iron particles are coated with a layer of polymeric resin with a high glass transition temperature to allow the compacted SMC core to be heat treated. The glass transition temperature of the selected thermoplastic polymers should be >250° C. Suitable resins include polyphenylene ether, polyethersulfone or polyetherimide polymeric resin. SMCs can be prepared by first coating the iron particles with phosphoric acid and then with a thermoplastic resin.

### Lubricating Agent

The addition of a lubricating agent allows easy ejection of compacted iron components during demoulding. In general, the density of the lubricating agent is <2.0 g/cm³, which is low when compared to the density of iron metal (˜7.78 g/cm³). The amount of lubricating agent used should therefore be kept to a minimum. A typical amount varies between 0.05 and 1.0 weight % of the coated-iron powder. The lubricating agents can be divided into two types: inorganic/organometallic ones and organic ones. Examples of inorganic/organometallic lubricants include zinc stearate, lithium stearate, and alkyl-trimethoxysilanes. Examples of organic lubricants include fatty acids having C12-C22, such as stearic acid or fatty acid amides such as stearamide and ethylene-bis-stearamide (EBS). One advantage of using an organic lubricant is that after heat treatment, the lubricant will not leave any residual materials in the iron core. The lubricant can be used either internally, premixing it with the coated iron powder, or externally, by lubricating the die wall. In the examples below, the lubricant is an organic fatty acid or a fatty acid amide such as stearic acid, stearamide or EBS. The lubricant is dissolved in a solvent such as ethanol or isopropanol, and then coated onto the insulated iron powder.

The present disclosure describes an SMC material that has at least one insulating spacer layer of nanoparticles. The SMC comprises a ferromagnetic iron powder having irregular particle shapes and sizes ranging from 10 to 600 microns. The surface of the powder is covered by an electrically insulating coating material. The electrically insulating inorganic nanoparticles come from materials such as alumina, silica, talc and aluminosilicates. The insulated ferromagnetic iron powder forms the desired SMC. The use of the nanoparticles as a spacer layer enhances the electrical insulation capability of the ferromagnetic iron powder. The present disclosure also describes a method of making this insulated ferromagnetic iron powder. The suspension, which contains nanoparticles and a solvent, is added to the iron powder. The mixing together of the iron powder and the nanoparticles is achieved using a blender or other mechanical stirring devices. The mixture is dried in a vacuum oven to remove the solvent. An organic lubricant is added to facilitate the demoulding of the components after the compaction of the mixture at high temperatures.

### Materials

Halloysite and kaolin are forms of clay with the empirical formula of Al₂Si₂O₅(OH)₄. They can be found in natural environments and are electrically nonconductive with very good thermal stability. The main constituents of these materials are aluminum, silicon, oxygen and hydrogen. Halloysite and kaolin have highly diversified morphologies (particles or tubes) with sizes ranging from a few nanometers to sub-microns and specific surface areas (calculated by the BET method) of 20-30 m²/g.

Nano-silica particles are commercially available. The ones manufactured by Degussa carry the trade name of Aerosil. A full range of silica nanoparticles ranging from a few nanometers up to micrometers is available commercially. Aerosil R-202 used in the examples below is believed to have an average particle size of about 14 nm and a specific surface area of approximately 110 m²/g measured by the BET method.

Halloysite-MP (HNT-MP) was supplied by Imerys Tableware Asia Limited, New Zealand, and was used without purification. Aerosil-R202 was supplied by Degussa. Iron powders Fe-100-mesh, Fe-80-mesh and Fe-40-mesh were purchased from various companies. The iron powder with average particle size <10 micron was supplied by Merck (see Table 1). Organic lubricants (stearic acid and stearamide) were supplied by International Lab and used as received. Fe-Coarse-A was prepared with Fe-40-mesh and Fe-100-mesh.

TABLE 1
Iron powder analysis.

| | | | Particle Size Distribution | |
|---|---|---|---|---|
| Iron Powder | Mole % (Element) | | Particle Sizes (μm) | Weight % |
| Fe-40-mesh | 0.69 | (Si) | 500250 | 30.4 |
| | 0.03 | (P) | 250-150 | 65.6 |
| | 0.06 | (S) | 125-75 | 2.8 |
| | 99.22 | (Fe) | 75-45 | 0.9 |
| | | | <45 | 0.3 |
| Fe-80-mesh | 0.65 | (Si) | 500-250 | 0.1 |
| | 0.08 | (Cr) | 250-150 | 74.1 |
| | 99.27 | (Fe) | 125-75 | 16.1 |
| | | | 75-45 | 5.7 |
| | | | <45 | 4.1 |
| Fe-100-mesh | 0.77 | (Si) | 500-250 | 0.0 |
| | 0.05 | (P) | 250-150 | 16.3 |
| | 99.18 | (Fe) | 125-75 | 30.6 |
| | | | 75-45 | 29.9 |
| | | | <45 | 23.8 |
| Fe-Coarse-A | 0.66 | (Si) | 500-250 | 22.0 |
| | 0.06 | (P) | 250-150 | 61.0 |
| | 99.28 | (Fe) | 125-75 | 14.0 |
| | | | 75-45 | 2.5 |
| | | | <45 | 0.5 |
| Merck-Fe | >99.9 | (Fe) | <10 | 100.0 |

### Preparation of HNT-SDS

Sodium-dodecyl-sulphate-treated halloysite nanotubes (HNT-SDS) were prepared by suspending the halloysite (HNT-MP) (35 g) in deionized water (500 ml) containing sodium dodecyl sulphate (1.0 g) at room temperature. A milky suspension was obtained after rigorous stirring. Then most of the water was removed by leaving the suspension in a ventilated fume hood overnight and by drying the suspension in a vacuum oven at 45° C. for 20 hr. Finally, a white powder was produced. HNT-SDS can be easily dispersed in either isopropyl alcohol or water.

### Example 1

Preparation of SMC materials coated with 6 vol. % HNTs for electrical insulation (Sample S1).

A mixture containing Fe-80-mesh (216.0 g) and Merck-Fe (24.0 g) was first prepared. A suspension of HNT-SDS (4.8 g) in isopropyl alcohol (100 ml), which was prepared by suspending the halloysite in the alcohol, was added to the mixture. This mixture was mechanically stirred at 300 to 1000 rpm under air flow to remove the solvent. About 1 wt % of a stearic acid organic lubricant, which was dissolved in isopropyl alcohol (50 ml) at 50° C., was added to the halloysite-coated iron powder. The resulting mixture was stirred under air flow until 95% of the solvent was removed. Then the powder was dried in a vacuum oven at 45° C. for 12 h upon which a grey powder was obtained.

### Example 2

Preparation of SMC materials coated with 6 vol. % HNTs for electrical insulation (Sample S2).

A suspension of HNT-SDS (4.8 g) in isopropyl alcohol (100 ml), which was prepared by suspending the halloysite in the alcohol, was added to Fe-80-mesh (240.0 g). This powder mixture was mechanically stirred at 300 to 1000 rpm under air flow to remove the solvent. About 1 wt % of a stearamide organic lubricant, which was dissolved in isopropyl alcohol (50 ml) at 50° C., was added to the halloysite-coated iron powder. The resulting mixture was stirred under air flow until 95% of the solvent was removed. Then the powder was dried in a vacuum oven at 45° C. for 12 h upon which a grey powder was obtained.

### Example 3

Preparation of phosphate-coated SMCs (Sample S3).

A mixture of Fe-80-mesh (240 g) and acetone (100 ml) was mechanically stirred at 300 to 1000 rpm for 30 min. Phosphoric acid (85 wt %) (4.6 g) diluted in acetone (50 ml) was slowly added to this mixture, which was further stirred for 30 minutes. After about 80 to 90% of the solvent was evaporated off, an organic lubricant consisting of stearamide (2.3 g) in isopropyl alcohol (50 ml) was added to the phosphate-coated iron powder at 50° C. The mixture was mechanically stirred until about 95% of the solvent was removed. Then the resulting powder was further dried in a vacuum oven at 45° C. for 12 h upon which a grey powder was obtained.

### Example 4

Preparation of SMC materials coated with 6 vol.% nano-sized silica for electrical insulation (Sample S5).

A suspension of Aerosil-R202 (2.4 g) in isopropyl alcohol (50 ml), which was prepared by suspending the Aerosil in the alcohol, was added to Fe-40-mesh (120.0 g). This mixture was mechanically stirred at 300 to 1000 rpm under air flow to remove the solvent. Then 0.5 wt % of a stearamide organic lubricant, which was dissolved in isopropyl alcohol (30 ml) at 50° C., was added to the silica-coated iron powder. The resulting mixture was stirred under air flow until 95% of the solvent was removed. Then the powder was dried in a vacuum oven at 45° C. for 12 h upon which a grey powder was obtained.

### Example 5

Preparation of SMC materials coated with 1 vol. % HNTs for electrical insulation (Sample S6).

A suspension of HNT-SDS (1.6 g, 1 vol. %) in isopropyl alcohol (100 ml), which was prepared by suspending the halloysite in the alcohol, was added to Fe-Coarse-A (480.0 g). This powder mixture was mechanically stirred at 300 to 1000 rpm under air flow to remove the solvent. Then stearamide (1.2 g, 0.25 wt %), an organic lubricant, was dissolved in isopropyl alcohol (50 ml) at 50° C., and added to the halloysite-coated iron powder. The resulting mixture was stirred under air flow until 95% of the solvent was removed. Then the powder was dried in a vacuum oven at 50° C. for 20 h upon which a grey powder was obtained.

### Example 6

SMC materials coated with 1 vol. % nano-sized silica for electrical insulation (Sample S7).

A suspension of Aerosil-R202 (1.6 g, 1 vol. %) in isopropyl alcohol (100 ml), which was prepared by suspending the Aerosil in the alcohol, was added to Fe-Coarse-A (480.0 g).

A suspension solution of Aerosil-R202 (1.6g, 1 vol. %) in isopropyl alcohol (100 ml) was prepared by suspending the Aerosil in the alcohol and added to iron powder Fe-Coarse-A (480.0g) with mechanical stirring. This powder mixture was mechanically stirred at 300 to 1000 rpm under air flow to remove the solvent. Then stearamide (1.2 g, 0.25 wt %) , an organic lubricant, was dissolved in isopropyl alcohol (50 ml) at 50° C., and added to the silica-coated iron powder. The resulting mixture was stirred under air flow until 95% of the solvent was removed. Then the powder was dried in a vacuum oven at 49° C. for 20 h upon which a grey powder was obtained.

### Example 7

Preparation of SMC materials coated with 0.5 vol. % nano-sized silica for electrical insulation (Sample S12).

A suspension of silica (0.8 g, 0.5 vol. %, 7 nm) in isopropyl alcohol (100 ml), which was prepared by suspending the silica in the alcohol, was added to Fe-Coarse-A (480.0 g). This powder mixture was mechanically stirred at 300 to 1000 rpm under air flow to remove the solvent. Then stearamide (1.2 g, 0.25 wt %), an organic lubricant, was dissolved in isopropyl alcohol (50 ml) at 50° C., and added to the silica-coated iron powder. The resulting mixture was stirred under air flow until 95% of the solvent was removed. Then the powder was dried in a vacuum oven at 49° C. for 20 h upon which a grey powder was obtained.

### SMC Core Sample Preparation

Toroid-shaped samples with dimensions of 24 mm (external diameter) x 17 mm (internal diameter) x ˜5 mm (length) were prepared by compaction of the HNT-treated iron powder under a static pressure of 1000 MPa at (a) room temperature (green compaction) and (b) 150° C. (warm compaction). Then the compressed core ring samples were heat treated either (A) at 250° C. for 10 min. and then at 530° C. for 10 min. or (B) at 250° C. for 10 min. and then at 500° C. for 30 min.

### Characterization

The density of the samples was determined by the Archimedes principle. DC magnetic properties, including maximum permeability (μm), saturation magnetic induction (Bs) and coercivity (Hc) were determined with a hysteresisgraph equipment model MATS-20105 from Hunan Linkjoin Technology Co., Ltd. of China. To measure the resistivity (p), the sample was placed between two conducting copper plates. The resistance (R) across the sample was measured by a four-point probe method with a multi-meter (model HP34401A). Then the resistivity (p) of the sample was calculated using equation 1, where A is the cross-sectional area and 1 is the length of the sample:

$$ρ = R \cdot \frac{A}{l} \qquad Equation ( 1 )$$

### Results

Table 2 shows the compositions of the SMCs prepared by the method described above. Ring-shaped samples were prepared by green compaction or warm compaction of the powder at 1000 MPa. Then the samples were heat treated at 530° C. for 10 min. or at 500° C. for 30 min. to reduce compressive residual stresses.

TABLE 2
SMC compositions.

| SMC Sample | Iron Powder | Coating | Lubricant |
|---|---|---|---|
| S1 | Fe-80-mesh and | HNT-SDS | Stearic acid |
| | Merck-Fe (<10 um, | (6 vol. %) | (1.0 wt %) |
| | 9:1) | | |
| S2 | Fe-80-mesh | HNT-SDS | Stearamide |
| | | (6 vol. %) | (1.0 wt %) |
| S3 | Fe-80-mesh | FePO₄ | Stearamide |
| | | (6 vol. %) | (1.0 wt %) |
| S4 | Fe-40-mesh | HNT-SDS | Stearamide |
| | | (6 vol. %) | (0.5 wt %) |
| S5 | Fe-40-mesh | Aerosil-R202 | Stearamide |
| | | (6 vol. %) | (0.5 wt %) |
| S6 | Fe-Coarse-A | HNT-SDS | Stearamide |
| | | (1 vol. %) | (0.25 wt %) |
| S7 | Fe-Coarse-A | Aerosil-R202 | Stearamide |
| | | (1 Vol. %) | (0.25 wt %) |
| S8 | Fe-100-mesh | HNT-SDS | Stearamide |
| | | (1 vol. %) | (0.25 wt %) |
| S9 | Fe-40-mesh | HNT-SDS | Stearamide |
| | | (1 vol. %) | (0.25 wt %) |
| S10 | Fe-40-mesh | Kaolin | Stearamide |
| | | (1 vol. %) | (0.25 wt %) |
| S11 | Fe-40-mesh | Ti-R-706 | Stearamide |
| | | (1 vol. %) | (0.25 wt %) |
| S12 | Fe-Coarse-A | Silica 7 nm | Stearamide |
| | | (0.5 Vol. %) | (0.25 wt %) |

Table 3 shows magnetic properties, densities and resistivities of the SMC core samples prepared by cold compaction at 1000 MPa at room temperature followed by heat treatment at 530° C. for 10 min. The characteristics are shown for densities of S1 to S12. The densities of S1 to S5 fell between 6.78 and 7.22 g/cm³. The core sample S3 containing phosphate had the lowest core density of 6.78 g/cm³ while S4 had the highest core density of 7.22 g/cm³. Even at a fixed 6 vol. % of insulating coating material, the densities of the SMCs containing different insulating coating materials with similar apparent densities varied significantly as shown in Table 3. These results also suggest that a higher compacted core density can be achieved when the SMC (e.g., S4) contains a higher concentration of larger iron particles (e.g., Fe-40-mesh).

The resistivities of S1 to S5 fell between 0.61 and 2.55 ohm·cm. The resistivities of S1, S2, S4 and S5 suggest that the insulating coating in these samples can effectively lower the eddy current losses. The maximum permeabilities of S1, S2, S3 and S4, which were coated with nanoparticles for electrical insulation, were higher than the maximum permeability of S3, which was phosphate treated.

TABLE 3
Magnetic properties, densities and resistivities of the SMC core
samples prepared by cold compaction at 1000 MPa at room temperature
followed by heat treatment at 530° C. for 10 min.

| | | | Maximum | Magnetic |
|---|---|---|---|---|
| SMC | Density | Resistivity | Permeability | Saturation |
| sample | (g/cm³) | (ohm · cm) | (k) | (T) |
| S1 | 7.15 | 1.77 | 0.1241 | 0.77 |
| S2 | 7.15 | 2.55 | 0.1939 | 0.85 |
| S3 | 6.78 | 0.88 | 0.0634 | 0.51 |
| S4 | 7.22 | 0.61 | 0.3450 | 1.20 |
| S5 | 7.11 | 1.42 | 0.1110 | 0.79 |

Table 4 shows magnetic properties, densities and resistivities of the SMC core samples prepared by cold compaction at 1000 MPa at room temperature followed by heat treatment at 500° C. for 30 min. From Table 4, it can be seen that the SMC iron cores after green compaction and heat treatment were much denser (i.e., >7.4 g/cm³) than S1 to S5 (see Table 3). The resistivities of most core samples were ˜0.04 ohm·cm (except for S9 which was 0.40 ohm·cm).

S6 to S10 had high densities and magnetic saturations. They also had high maximum magnetic permeabilities between 0.396 k and 0.456 k. S6 and S9, which contained a relatively higher concentration of larger iron particles (500-250 microns), had higher densities and magnetic permeabilities than did S8. These results suggest that both iron powders (Fe-40-mesh and Fe-Coarse-A) can be used to prepare high density iron cores. In addition, a lower concentration of electrical insulating coating material helps to achieve/preserve high densities and produce good magnetic properties.

TABLE 4
Magnetic properties, densities and resistivities of the SMC core
samples prepared by cold compaction at 1000 MPa at room temperature
followed by heat treatment at 500° C. for 30 min.

| | | | Maximum | Magnetic |
|---|---|---|---|---|
| SMC | Density | Resistivity | Permeability | Saturation |
| sample | (g/cm³) | (ohm · cm) | (k) | (T) |
| S6 | 7.49 | 0.04 | 0.4457 | 1.43 |
| S7 | 7.46 | 0.04 | 0.4567 | 1.45 |
| S8 | 7.46 | 0.04 | 0.3964 | 1.23 |
| S9 | 7.53 | 0.40 | 0.4146 | 1.43 |
| S10 | 7.46 | 0.03 | 0.4344 | 1.45 |

The previous examples have shown that higher density SMC cores have better magnetic properties. Techniques for producing high density SMC samples should therefore be developed. For instance, a higher compacting pressure can be used. In the preparation of a SMC with a thin layer of electrical insulating coating, an organic lubricant can be used with warm compaction.

Table 5 shows magnetic properties, densities and resistivities of SMC core samples prepared by warm compaction 150° C. at 1000 MPa followed by heat treatment at 500° C. for 30 min. Table 5 shows the results of the SMC sample cores prepared by the warm compaction technique which required the pre-heating of the SMC powder and the compacting tooling to 150° C. The densities obtained using warm compaction were between 0.6 and 0.8%, which are higher than those produced using the cold compaction method. As a result, most samples (except S7) had a higher maximum magnetic permeability. Samples S6 and S9 had a maximum magnetic permeability of 0.5 k. It is unclear to us as to why S7, which was prepared by warm compaction, had a lower maximum permeability than the rest. The results shown in Table 5 suggest that warm compaction is a relatively easy way to increase the sample density.

Table 5 also shows that both S11 (with titanium dioxide nanoparticles as the electrical insulating coating) and S12 (with a smaller amount of smaller silica nanoparticles as the electrical insulating coating) exhibited improved magnetic properties.

TABLE 5
Magnetic properties, densities and resistivities of SMC
core samples prepared by warm compaction 150° C. at
1000 MPa followed by heat treatment at 500° C. for 30 min.

| | | | Maximum | Magnetic |
|---|---|---|---|---|
| SMC | Density | Resistivity | Permeability | Saturation |
| sample | (g/cm³) | (ohm · cm) | (k) | (T) |
| S6 | 7.55 | 0.07 | 0.5052 | 1.61 |
| S7 | 7.52 | 0.03 | 0.4145 | 1.49 |
| S8 | 7.54 | 0.03 | 0.4894 | 1.66 |
| S9 | 7.58 | 0.03 | 0.5201 | 1.57 |
| S10 | 7.57 | 0.03 | 0.4949 | 1.57 |
| S11 | 7.60 | 0.01 | 0.5389 | 1.52 |
| S12 | 7.58 | 0.01 | 0.5819 | 1.53 |

The actual performance of the SMCs was measured in a dynamometer test. S6 and S7, together with Somaloy-500 and Somaloy-700, were used to produce the magnetic cores for DC motors which were designed to work at a torque of 2.5 kg-cm. The output power and the efficiency at that torque were measured. The magnetic cores were fabricated according to the following procedure. 120 g of SMC powder was cold compacted under 1000 MPa and then heat treated at 500° C. The core densities of the magnets prepared from S6 and S7 were 7.32 and 7.28 g/cm³, respectively, which were lower than the core densities of the magnets prepared from the Somaloy samples. However the dynamometer test indicates that the motors prepared with S6 and S7 had excellent performance efficiency and were better than the motor prepared with Somaloy-500, although slightly inferior to the one prepared with Somaloy-700 (see Table 6).

TABLE 6
Dynamometer test

| | Density | Speed | Current | Output Power | Efficiency |
|---|---|---|---|---|---|
| SMC Sample | (g/cm³) | (rpm) | (A) | (W) | (%) |
| Somaloy-500 | 7.469 | 3650 | 1.095 | 95.1 | 76.1 |
| Somaloy-700 | 7.516 | 3653 | 1.002 | 93.5 | 82.5 |
| S6 | 7.327 | 3928 | 1.102 | 101 | 80.5 |
| S7 | 7.288 | 3941 | 1.134 | 101.4 | 78 |

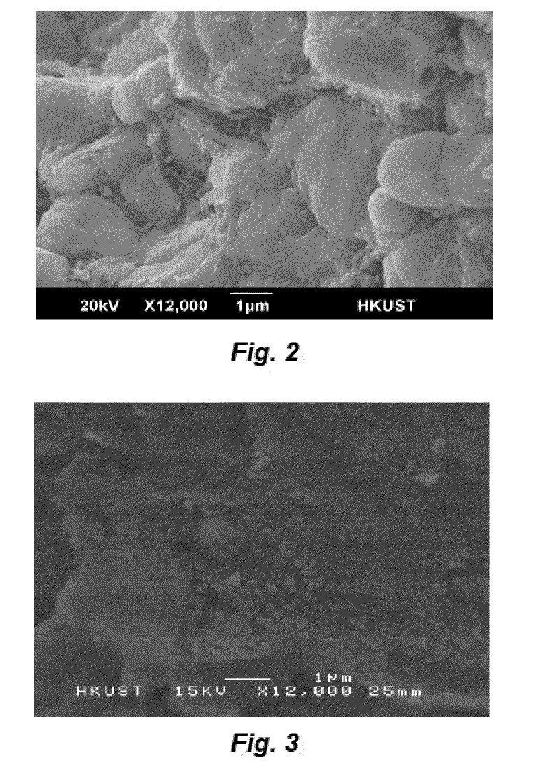

FIG. 2 is a SEM photomicrograph of S4 comprising iron particles coated with HNTs for electrical insulation. FIG. 3 is a SEM photomicrograph of S5 comprising iron particles coated with nano-sized silica (Aerosil R-202) for electrical insulation. The photomicrographs clearly show that the nano-sized insulating coating was still intact even after the high pressure compaction process and the heat treatment.

### Conclusion

SMCs consisting of ferromagnetic iron particles having irregular shapes and sizes ranging from 10 to 600 microns were successfully fabricated. These iron particles were coated with a 0.5 to 6.0 vol. % electrical insulating material formed by mixing together an organic lubricant and nanoparticles. As described, the insulating inorganic nanoparticles came from materials such as alumina, silica, talc and aluminosilicates. The proposed methodology uses non-conductive nanoparticles as an electrical insulating layer or as a spacer. The resistivities of the compacted core SMC samples after heat treatment varied from 0.01 ohm·cm to 2.55 ohm·cm. The results indicate that high density (>7.5 g/cm³) SMC magnetic core samples having a nano-sized electrical insulating coating have a better magnetic properties (e.g., higher maximum permeability) than the low density sample core.

It should be understood that the details, materials, steps and arrangement of parts, which have been herein described and illustrated to explain the nature of the subject matter, may be modified by those skilled in the art within the principle and scope of the invention as expressed in the appended claims.

1-21. (canceled)

22. Method of forming a soft magnetic composite (SMC) material, said method comprising:
forming atomized ferromagnetic particles of a predetermined size range;
coating the particles with at least one layer of electrically insulating inorganic nanofillers to form an insulated ferromagnetic powder as the SMC material; and
further coating the particles with a lubricating agent to facilitate demoulding.

23. The method according to claim 22, wherein the ferromagnetic powder comprises at least one material selected from the group consisting of iron, nickel, ferrosilicon alloys, ferrosilicon (FeSi) and ferronickel alloys (FeNi).

24. The method according to claim 22, wherein the coating the particles further comprises:
compacting the mixture at a high temperature; and
demoulding the compacted mixture.

25. The method according to claim 24, wherein
the lubricating agent comprises an organic lubricant.

26. The method of claim 24, further comprising:
selecting, as the lubricant an inorganic/oganometallic based lubricant.

27. The method according claim 24, wherein
the lubricating agent comprises an organic lubricant selected from the group consisting of fatty acids having C12-C22, and their derivatives such as stearic acid and fatty acid amides, such as stearamide and bisethylenestearamide.

28. The method according to any of claim 24, wherein
the lubricating agent comprises an organic lubricant applied by dissolving the lubricant in a solvent (e.g., alcohol) and then coating the insulated ferromagnetic powder with the dissolved solvent or without solvent.

29. The method according to claim 22, wherein the coating the particles further involves:
adding the ferromagnetic powder in the form of an iron powder to a suspension containing nanoparticles and a solvent;
mixing the iron powder and nanoparticles together by use of a mechanical stifling device; and
drying the mixture so as to remove the solvent.

30. The method according to claim 29, further comprises selecting a volume percentage of the iron powder in the range of 90.0-99.5 vol. % and a volume percentage of the insulating nanoparticles in the range of 0.5-10 vol. % of the total solid content.

31. The method according to claim 22, wherein the coating the particles further involves:
adding the ferromagnetic powder in the form of iron powder nanoparticles without solvent; and
mixing the iron powder and nanoparticles together by use of a mechanical stirring device.

32. The method according to claim 22, wherein the coating the particles further involves:
adding the ferromagnetic powder in the form of an iron powder to a suspension containing nanoparticles and a solvent or without solvent;
mixing the iron powder and nanoparticles together by use of a mechanical stirring device;
in the case of solvent present, drying the mixture so as to remove the solvent;
compacting the mixture at a high temperature; and
demoulding the compacted mixture.

33. The method according to claim 22, wherein the lubricating agent is provided at a weight percentage in the range of 0.1-2 wt % of the total solid content.

34. The method of claim 22, wherein the forming atomized ferromagnetic particles of a predetermined size range involves forming water-atomized iron particles or iron sponge having irregular shapes and sizes ranging from 10 to 600 microns.

35. The method of claim 22, wherein the electrical insulating inorganic nanofillers comprise a material selected from the group consisting of halloysite, kaolin, titanium dioxide, talc, alumina and silica.

36. The method of claim 22, wherein the inorganic fillers comprise at least one material selected from the group consisting of halloysite nanotubes (HNTs), kaolin, titanium dioxide, talc, alumina and silica.

37. The method of claim 22, wherein:
the inorganic fillers comprise halloysite nanotubes (HNTs); and
the electrical insulating halloysite nanotubes (HNTs) have at least one dimension less than 250 nm.

38. The method according to claim 22, wherein
the inorganic fillers comprise halloysite nanotubes (HNTs);
the electrical insulating halloysite nanotubes (HNTs) have at least one dimension less than 200 nm.

39. The method of claim 22, wherein the electrically insulating nano-sized inorganic fillers comprise a material selected from the group consisting of halloysite and kaolin, with the empirical formula of Al₂Si₂O₅(OH)₄ , phosphoric acid (H₃PO₄) forming an insulating layer of iron phosphate (Fe₂PO₄), boric acid (H₃BO₃) combined with alkali compounds to form an insulating layer on the iron particle surface, and inorganic materials based materials containing at least two metal oxides layers from phosphoric acid, boric acid or silicic acid.

40. The method of any of claim 22, wherein
the inorganic fillers comprise electrical insulating nanotubes; and
the electrical insulating nanotubes have at least one dimension less than 200 nm.

41. The method of claim 22, wherein
the inorganic fillers comprise electrical insulating nanoparticles; and
the electrical insulating nanoparticles have at least one dimension less than 200 nm.

42. The method of claim 22, wherein the forming of atomized ferromagnetic particles of a predetermined size range comprises forming water-atomized iron particles or iron sponge having irregular shapes of sizes ranging from 10 to 600 microns.

43. Method of forming a soft magnetic composite (SMC) material, comprising the steps of:
forming atomized ferromagnetic particles of a predetermined size range;
coating the particles with at least one layer of electrically insulating inorganic nanofillers to form an insulated ferromagnetic powder as the SMC material;
further coating the particles with a lubricating agent to facilitate demoulding, wherein the lubricating agent comprises of an organic lubricant and an inorganic/oganometallic based lubricant;
compacting the mixture at a high temperature; and
demoulding the compacted mixture.
